(19) United States
(12) Patent Application Publication
(10) Pub. No.: US 2007/0194139 A1
(43) Pub. Date: Aug. 23, 2007

(54) Setback control for temperature controlled system

(75) Inventor: Bruce R. Beggs, Dayton, MN (US)

Correspondence Address: Mark A. Litman & Associates;York Business Center, Suite 205, 3209 West 76th St., Edina, MN, 55435, US

(73) Assignee: Minnesota IT Services

(21) Appl. No.: 11/360,783

(22) Filed: Feb. 23, 2006

(51) Int. Cl. F23N 5/20; G05D 23/00

(52) U.S. Cl. 236/46 R

(57) ABSTRACT

A program or subprogram in a processor, thermostat or computer that directs a temperature control system either contains or is programmable to contain an approximation that is applied to a setpoint temperature. In a heating environment, where a temperature setpoint is X degrees F. (X° F.), the approximation will assert a setpoint range of X−yF° (wherein y is the setpoint variation or approximation) such that when the actual temperature reaches X−y° F., the system will only then start the heating process when that X−y° F. temperature is reached. When the temperature control system is a cooling system, where a temperature setpoint is X degrees F. (X° F.), the approximation will assert a setpoint range of X+y° F. (wherein y is the setpoint variation or approximation) such that when the actual temperature reaches X+y° F., the system will only then start the cooling process when that X+y° F. temperature is reached. The significance of the process is that when a single absolute point temperature is selected, the start up event of heating or cooling is reached more frequently over a given period of time.

### BACKGROUND OF THE INVENTION

1. Field of the Invention

This invention relates to the field of temperature control, energy saving in temperature control systems, and computer programs executing processes in temperature control systems.

2. Background of the Art

The limitations on the supply of energy that have been recognized recently have stimulated significant efforts in energy conservation and in optimizing the performance of all systems that use non-renewable sources of energy. Even though electricity is not, in itself, a non-renewable energy source, it is still primarily the product of coal burning operations, as only minor percentages of electricity are produced by nuclear energy, thermal energy and wind energy. Although in some regions the use of hydroelectric power is a significant source of electrical energy, it is generally agreed that almost all locations have been tapped for hydroelectric energy. As populations have grown in regions served by hydroelectric energy, additional sources of energy are needed. Furthermore, the increased demand for energy has further driven up its cost, even as the supply has been maintained or diminished.

Conservation has been able to reduce the rate of growth, but not the growth itself. It is important that every available opportunity be taken to further improve the level of conservation in energy use to help in this global situation.

One significant area in which there is a high level of energy utilization is in the heating and cooling spaces and materials. The cost of refrigeration and air conditioning is particularly high, as both of those systems to drive mechanical devices (e.g., compressors) to remove energy from transported materials) moved by a fan, which means that two significant mechanical devices must be operated to cool, which is an inherently inefficient process to begin with. Electrical heating is only slightly more efficient, and the use of natural gas requires both the cost of the natural gas and the mass transport of the heated gas into the house. The potential for significant inefficiencies can be readily seen.

One particular issue with home and office heating is the fact that individuals tend to have mindsets or prejudices and become fixated on particular numbers rather than actual conditions. Persons tend to set temperatures at numbers they want rather than actually reasonable conditions. Therefore allowing people to set their own desired temperatures has some beneficial effects, there is still room for improving conservation levels.

One specific direction that has been taken in conservation is the setting of heating temperatures to a maximum limit and cooling temperatures to a minimum limit. Another feature is to have temperatures automatically controlled over time. This process is called time oriented setbacks. A computer or processor control directs the heating or cooling system to maintain temperatures according to the time of day. For example, in a home environment there is usually a schedule for the events of the day. The family may sleep from 11:00 p.m. to 7:00 a.m., leave the house at 8:30 a.m. and return at 3:30 p.m. (from school) and 6:00 p.m. from work on weekdays. A time oriented setback system would anticipate the (for example) heating requirements during winter months and program the heating system to allow temperatures of 64° F. from 11:00 p.m. to 6:30 a.m., 68° F. from 7:00 a.m. to 8:30 a.m., 64° F. from 8:30 a.m. to 3:00 p.m., and then back to 68° F. from 3:30 p.m. to 11:00 p.m. The temperatures may be varied during these periods, especially while individuals are away from the residence, and the computer control may impose a different time schedule and different temperatures over the weekend or holidays.

Many different controls and systems, including reporting systems have been used and combined in such time oriented setback systems.

Published U.S. Patent Application No. 20020077774 describes a thermostat receives requests to enter into setback modes of operation whereby at least one setpoint normally used by the thermostat is changed. The thermostat is operative to compute the integral of change in setpoint temperature over time during each setback mode of operation. The thermostat is also operative to maintain a running total of such computed integrals of change in setpoint temperature over time in order to respond to any request for such computed integrals. The thermostat is furthermore operative to set the total of such computed integrals of change in setpoint temperature over time equal to zero in response to a request to clear the total of such computed integrals of change in setpoint temperature over time. The thermostat will furthermore compute the integral of temperature offset occurring over any time left in any present setback mode of operation after implementing a requested clearing so as to thereby initiate the computation of a new running total of computed integrals of temperature offset occurring over time spent in setback modes of operation that are implemented after the clearing.

Published U.S. Patent Application No. 20030085021 describes the operation of an “Energy Optimizer” based on the fact that within any furnace there is an optimum operating temperature above which the furnace's heat exchanger reflects rather than absorbs any significant amount of additional thermal energy. Once that optimal heat exchanger temperature has been achieved, any continued application of thermal energy is typically reflected up the chimney as lost heat, wasted energy, and added pollutants to the atmosphere. The Energy Optimizer controls the operation of the furnace by continually sensing the slope or rate of change in temperature on the secondary side of the heat exchanger. This slope information is then stored for ongoing operational reference and control. In this way the Energy Optimizer manages the furnace's best (optimal), operating characteristics within the particular installed working environment. In addition, this slope information is interpreted to provide performance and operational safety related information.

Published U.S. Patent Application No. 20030121652 describes a digital programmable thermostat comprising up and down temperature adjustment buttons, an LCD display, and a Program button, which a user can simply press once to initiate a single setback program that sets back the last user selected temperature setting during a predetermined setback time period. The thermostat can also automatically set the current time and date, to allow the user to initiate the program without having to set the current time and date.

There presently exist numerous programmable thermostats that will allow a user to set back the temperature set point during select periods to provide energy savings. However, programming such a thermostat typically requires the user to complete a complex series of steps to select the temperatures and time periods before the user can initiate the set back program, or force the user to use a default program that does not ideally meet the user's schedule. As a result, such thermostat programs aren't utilized by many consumers. This problem of programming a thermostat is described in U. S. Pat. No. 5,782,296 (Mehta). Mehta describes a need for a user-friendly thermostat that operates as a manual thermostat at power-up, enabling the user to manually select a desired temperature immediately without having to spend time and effort programming the thermostat. It also describes a need for a thermostat that enables users to more easily customize or “program” their thermostats, as compared to existing “pre-programmed” thermostats. The thermostat in Mehta provides the user with an “Auto Prog” button that the user can press repeatedly to select from one of several arbitrary pre-programmed sets of times and temperatures, of which may not be based on any supporting consumer data. This requires the user to scroll through the pre-programmed sets to find one with a temperature setting and schedule that are satisfactory to the user.

Published U.S. Patent Application No. 20030150925 describes a thermostat that is operative to note the current temperature at time of entering into a setback of one or more previously established setpoints. The thermostat is also operative to note any newly defined setpoints. The thermostat also notes whether the setback is to occur in a heating or cooling mode of operation. The thermostat maintains a record of the aforementioned entry conditions as well as the amount of time the thermostat participates in a requested setback. The thermostat also preferably notes one or more setpoints and sensed temperature occurring at the end of an implemented setback as well as the ending heating or cooling mode of operation. A record of temperature conditions, mode of operation and elapsed time for each setback is stored for retrieval by a remotely located entity in communication with the thermostat. This entity is usually an energy provider. This record is available for retrieval at any time, including a time when the thermostat is presently implementing a setback.

U.S. Pat. No. 5,611,484 (Uhrich) describes a thermostat having terminals to receive at least two temperature sensor signals, and changes the one of these terminals that provides the feedback signal for temperature control responsive to a detected condition. This condition may be a manual input, expiry of a time interval, reaching a time of day, or the relative magnitudes of the temperatures encoded in the sensor signals.

This improvement comprises at least first and second temperature sensors each providing a sensor signal representative of the temperature ambient thereto. I contemplate that a sensor will be located in each of the areas where the occupants desire the temperature to be controlled. A sensor selection means receives each of the sensor signals, and includes a selectable control input, for providing a single one of said sensor signals designated by the control input to the control terminal of the control circuit. There are a number of preferred embodiments for the sensor selection means. In the simplest form, the sensor selection means comprises nothing more than a switch under manual control by the occupant. The occupant selects the active sensor by manipulating the switch. In more sophisticated embodiments, the sensor selection means may comprise a timer or clock to control the duration of the active interval for one of the sensors. In yet another embodiment, the actual level of the temperature sensed by one of the sensors, controls the selection of the active sensor.

U.S. Pat. No. 6,549,870 (Proffitt) describes a thermostat that receives requests to enter into setback modes of operation whereby at least one setpoint normally used by the thermostat is changed. The thermostat is operative to compute the integral of change in setpoint temperature over time during each setback mode of operation. The thermostat is also operative to maintain a running total of such computed integrals of change in setpoint temperature over time in order to respond to any request for such computed integrals. The thermostat is furthermore operative to set the total of such computed integrals of change in setpoint temperature over time equal to zero in response to a request to clear the total of such computed integrals of change in setpoint temperature over time. The thermostat will furthermore compute the integral of temperature offset occurring over any time left in any present setback mode of operation after implementing a requested clearing so as to thereby initiate the computation of a new running total of computed integrals of temperature offset occurring over time spent in setback modes of operation that are implemented after the clearing.

U.S. Pat. No. 6,254,009 (Proffitt) describes a thermostat that receives setpoint information from a system in communication with the thermostat. The thermostat is operative to modify any locally entered setpoints by a predefined amount dictated by the setpoint information received from the system in communication with the thermostat. The thermostat is preferably operative to continually display the time remaining during which it will be under the control of the system in communication with the thermostat. This affords an occupant of the room viewing the displayed time with an opportunity to elect to either continue or to override the control by the system in communication with the thermostat at any time.

### SUMMARY OF THE INVENTION

A program or subprogram in a processor or computer that directs a temperature control system either contains or is programmable to contain an approximation that is applied to a setpoint temperature. In a heating environment, where a temperature setpoint is X degrees F. (X° F.), the approximation will assert a setpoint range of X−yF° (wherein y is the setpoint variation or approximation) such that when the actual temperature reaches X−y° F., the system will only then start the heating process when that X−y° F. temperature is reached. When the temperature control system is a cooling system, where a temperature setpoint is X degrees F. (X° F.), the approximation will assert a setpoint range of X+y° F. (wherein y is the setpoint variation or approximation) such that when the actual temperature reaches X+y° F., the system will only then start the cooling process when that X+y° F. temperature is reached. The significance of the process is that when a single absolute point temperature is selected, the start up event of heating or cooling is reached more frequently over a given period of time. While even though the heating system or cooling system might run for a longer period of time during each heating or cooling cycle, the temperature control process is actually least efficient during the initial start up period (particularly in the cooling process) so that the reduction of the number of startups increases the overall efficiency.

### BRIEF DESCRIPTION OF THE INVENTION

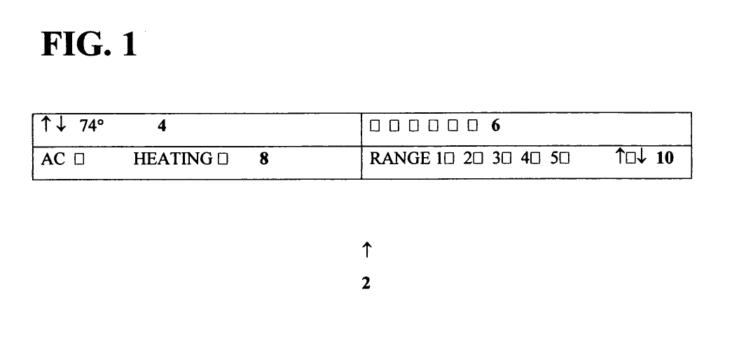

FIG. 1 is a block diagram of a system constructed according to practice of the invention.

### DETAILED DESCRIPTION OF THE INVENTION

A temperature control system (heating or cooling system) is controlled by a memory and/or processor system. There is a program or subprogram in the processor or computer (e.g., hardware) that directs the temperature control system. That system either contains or is programmable to contain an approximation point, range or approximation temperature that is applied to a setpoint temperature. In a heating environment, where a temperature setpoint is by way of an example X degrees F. (X° F.), the approximation will assert a setpoint range of X−yF° (wherein y is the setpoint variation or approximation) such that when the actual temperature reaches X−y° F., the system will only then start the heating process.when that X−y° F. temperature is reached. When the temperature control system is a cooling system, where a temperature setpoint is X degrees F. (X° F.), the approximation will assert a setpoint range of X+y° F. (wherein y is the setpoint variation or approximation) such that when the actual temperature reaches X+y° F., the system will only then start the cooling process when that X+y° F. temperature is reached. The significance of the process is that when a single absolute point temperature is selected, the start up event of heating or cooling is reached more frequently over a given period of time. While even though the heating system or cooling system might run for a longer period of time during each heating or cooling cycle, the temperature control process is actually least efficient during the initial start up period (particularly in the cooling process) so that the reduction of the number of startups increases the overall efficiency.

A Selective Setback Range would be a program or control that allows the heat pump, furnace, air conditioner, freezer, refrigerator, process control, etc.) to be set or selectively set for a specific setback temperature range, as opposed to a single set point temperature typically used in today's thermostats or temperature controls. The system may allow a single set point temperature as well as a range according to the present technology. In the case of heating, as soon as the thermostat is satisfied by attaining the high set point of the selected range, the new technology then would automatically set itself back to the low set point in the selected range. Once the thermostat calls for heat (the low set point), it would again automatically set itself to the high set point until satisfaction, and the cycle continues. For cooling, the set points would operate in an essentially opposite format, by allowing the actual temperature to rise to the extreme end of the range before actual cooling until the actual target temperature is achieved. This allows the heating/cooling idle time to be extended between cycles, resulting in increased energy savings, even though the length of time that each heating or cooling cycle may be extended during operation.

It should be noted that the initial startup period for the cooling or heating cycle is the most inefficient period of operation of a temperature control system. For example, consider the typical cooling system. A temperature exchange interface would typically exist where a cooled fluid on one side of a thermally conductive separator (e.g., a metal sheet or metal tube wall) and on the other side is a fluid that is to be cooled. The cooling is effected by the equally inefficient heat sink technology of heat being transferred from the higher temperature mass to the lower temperature mass, thus cooling the higher temperature mass. There is an added inefficiency at the initiation of a cycle, because the cooling mass (lowest temperature mass) must be cooled and the interface also has to be cooled by the exchange process. If the process were running in a constant or approximately continuous cooling process, the amount of cooling of the cooling mass would be minimal and there would be non-existent cooling of the interface. This continual process, however, would be highly energy consumptive.

To be most effective, the thermostat device would ideally offer a default Selective Setback Range (individually controlled or multiple ranges available) of approximately at least 1 or 2 degrees, with the ability of the user to program or input a different Selective Setback Range feasible for their particular application or use. At any point while the Selective Setback Range program is running, the consumer could manually override it to raise or lower the set point to their desired temperature.

An example of this application might be: where a consumer is most comfortable with a 70° Fahrenheit environment (the high set point for heating), but would be fine at 68° (the low set point for heating) in order to realize energy savings, he/she could set the Selective Setback Range for 3 degrees (68, 69 and 70) with the high set point of 70 degrees Fahrenheit.

FIG. 1 shows a schematic of the controls of a thermal regulation system 2 performing the technology described herein. The system 2 is shown with four separate input areas. A first input area 4 controls the actual target temperature setting. A second input area 6 controls time settings with button inputs. A third input area 8 designates the temperature control function, as in a residential setting, between air conditioning (AC) and heating. A fourth input area 10 controls the setback range either by the specific temperature range buttons with setback temperature ranges of 1, 2, 3, 4 or 5 degrees, or by setting a range with the up arrow down arrow controls. The arrows may control whole degrees or fractional degrees.

The system of the technology described herein has been primarily described with a manual (e.g., touchpad, keyboard, touchscreen) input, but other input formats are also available, as with RF controls, or other wireless systems. The input may be achieved by a two-way communicating thermostat having a transceiver associated therewith for receiving information from a system in communication with the thermostat. The thermostat may be operative to display certain of the received information when it is under the control of the system in communication with the thermostat. The thermostat is preferably operative to modify any locally entered setpoints or setback ranges by a predefined amount dictated by the system in communication with the thermostat. In this manner, there is a continued modification of locally entered setpoint information when determining the operating setpoint of the thermostat while under the setpoint control dictated by the system in communication with the thermostat.

The thermostat furthermore is preferably operative to continually display the time remaining during which it will be under the control of the system in communication with the thermostat. This affords an occupant of the room viewing the displayed time with an opportunity to elect to either continue or to override the control of the system in communication with the thermostat at any time. In the event that the occupant elects an override, the thermostat immediately exits from the setpoint control dictated by the system in communication with the thermostat and resumes local setpoint control as defined by local entries of setpoint information to the thermostat.

The thermostat preferably remains in an override status once an override has been elected until such time as a reset is internally authorized within the thermostat in accordance with a schedule of times for such resetting. The thermostat continues to override any further requests to control setpoints by the system in communication with the thermostat until such internal resetting of the override occurs.

A thermostat may be operatively connected to a transceiver via a communication line or wireless connection so as to receive or transmit information to the transceiver. The thermostat includes a display, which is preferably a liquid crystal display as well as a plurality of touch sensitive buttons. These touch sensitive buttons include a touch sensitive button that can be depressed at any time by one viewing the display. In particular, the touch sensitive button or panel may be depressed when one wishes to override a mode of operation indicated on the display. The transceiver may provide a communication link between the thermostat and a hierarchical control system providing specific setpoint control information to the thermostat. The hierarchical control system is preferably under the control of an energy provider seeking to provide cost-effective setpoint control information to the thermostat.

The processor or microprocessor may also execute a program stored in the memory that processes information received from the transceiver via the line. This latter program, when executed by the microprocessor, will cause certain modifications to be made to the locally entered setpoints that have also preferably been stored in the memory. The program will also cause the microprocessor to execute the one or more programs stored in memory which control an HVAC system. These control programs will now however monitor any variation of the temperature indicated by the temperature sensor with respect to the locally setpoints as modified. The program will also preferably cause the microprocessor to display certain information on the display that has been received from the transceiver via line. The displayed information will include an indication as to the time remaining during which the locally entered setpoints are to be subject to the aforementioned modifications.

What is claimed is:

1. A system for controlling a temperature range comprising:
a thermostat; and a device for altering or maintaining the temperature range; wherein the thermostat directs temperatures to be altered and maintained by the device by input of at least a target temperature and wherein the thermostat allows input of a setback range for the target temperature.

2. The system of claim 1 wherein the thermostat directs a heating device.

3. The system of claim 1 wherein the thermostat directs a cooling device.

4. The system of claim 1 wherein the thermostat directs both a cooling and a heating device.

5. The system of claim 1 wherein the thermostat allows specific selection of a particular setback range with a single button.

6. The system of claim 1 wherein the thermostat allows specific selection of the setback range may be selected by manual input into the thermostat.

7. The system of claim 5 wherein the thermostat also allows setting times of the day when the target temperature is to be controlled by the device.

8. The system of claim 6 wherein the thermostat also allows setting times of the day when the target temperature is to be controlled by the device.

9. The system of claim 5 wherein the thermostat comprises a processor.

10. The system of claim 6 wherein the thermostat comprises a processor.

11. A method of conserving energy in a thermal control system comprising setting a setpoint temperature for the thermal control system and inputting a setback range to overlap the setpoint temperature, the overlap extending to temperatures higher than the setpoint temperature in a cooling thermal control system and lower than the setpoint temperature in a heating control system.

12. The method of claim 11 wherein in a heating environment, where a temperature setpoint is X° F., the approximation will assert a setback range of X−yF°, wherein y is the setpoint variation such that when the actual temperature reaches X−y° F., the thermal control system will only then start a heating process.

13. The method of claim 11 wherein in a cooling environment, where a temperature setpoint is X° F., the approximation will assert a setback range of X+yF°, wherein y is the setpoint variation such that when an actual temperature in the cooling environment reaches X+y° F., the thermal control system will only then start a cool process.

14. The method of claim 11 wherein a user inputs the setback range by a control panel associated with a thermostat in the thermal control system.

15. The method of claim 12 wherein a user inputs the setback range by a control panel associated with a thermostat in the thermal control system.

16. The method of claim 13 wherein a user inputs the setback range by a control panel associated with a thermostat in the thermal control system.

17. The method of claim 11 wherein inputting the setpoint variation is effected by pressing a button or touchscreen for a specific temperature range for the setpoint variation.

18. The method of claim 11 wherein inputting the setpoint variation is effected by pressing a button or touchscreen to create a specific temperature range for the setpoint variation.

19. A thermostat connected to a device for altering or maintaining the temperature range; wherein the thermostat directs temperatures to be altered and maintained by the device by input of at least a target temperature and wherein the thermostat allows input of a setback range for the target temperature.

20. The thermostat of claim 19 wherein the thermostat allows at least one function selected from the group consisting of specific selection of a particular setback range with a single button, selection by manual input into the thermostat and setting times of the day when the target temperature is to be controlled by the device.
